(19) United States
(12) Patent Application Publication
(10) Pub. No.: US 2024/0053940 A1
(43) Pub. Date: Feb. 15, 2024

(54) MONITORING APPARATUS, MONITORING METHOD, AND NON-TRANSITORY COMPUTER READABLE MEDIUM

(71) Applicant: FUJIFILM Business Innovation Corp., Tokyo (JP)

(72) Inventor: Ayumi TSUJI, Kanagawa (JP)

(73) Assignee: FUJIFILM Business Innovation Corp., Tokyo (JP)

(21) Appl. No.: 18/179,553

(22) Filed: Mar. 7, 2023

(30) Foreign Application Priority Data
Aug. 10, 2022 (JP) 2022-128346

(51) Int. Cl. G06F 3/12

(52) U.S. Cl. CPC G06F 3/1273; G06F 3/1224; G06F 3/1259

(57) ABSTRACT

A monitoring apparatus includes a processor configured to: in a case where printing information of an image forming apparatus managed by an audit log server contains information indicating that a specified document specified in advance has been printed by the image forming apparatus, cause the audit log server to notify a document manager who manages the specified document of contents of an audit log that records a fact that the specified document has been printed.

### CROSS-REFERENCE TO RELATED APPLICATIONS

This application is based on and claims priority under 35 USC 119 from Japanese Patent Application No. 2022-128346 filed Aug. 10, 2022.

### BACKGROUND

### (i) Technical Field

The present disclosure relates to a monitoring apparatus, a monitoring method, and a non-transitory computer readable medium.

### (ii) Related Art

In Japanese Unexamined Patent Application Publication No. 2007-310820, a printing system in which a document creation apparatus and a management apparatus are network-connected to each other is described. In the printing system, the document creation apparatus includes metadata generating means for generating metadata on paper, and the management apparatus includes metadata analyzing means for analyzing metadata, and notifying means for, when a copying or transmitting operation is executed, notifying a destination specified based on notifying means data contained in metadata of the execution of the copying or transmitting operation.

### SUMMARY

In places such as shared offices, an unspecified number of people use an image forming apparatus such as a printer to print documents and the like. In such a shared office, an audit log that records the fact that a document or the like has been printed is not easily available. Thus, a document manager who has created a highly confidential document is not able to know that the document has been printed by another user. For example, the document manager is not able to know that even a document that has been specified by him or her as a highly confidential document has been printed using an image forming apparatus by another user.

Aspects of non-limiting embodiments of the present disclosure relate to allowing a document manager to know that a document specified by the document manager has been printed by another user.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a monitoring apparatus including a processor configured to: in a case where printing information of an image forming apparatus managed by an audit log server contains information indicating that a specified document specified in advance has been printed by the image forming apparatus, cause the audit log server to notify a document manager who manages the specified document of contents of an audit log that records a fact that the specified document has been printed.

### BRIEF DESCRIPTION OF THE DRAWINGS

Exemplary embodiments of the present disclosure will be described in detail based on the following figures, wherein:

FIG. 1 is a schematic diagram illustrating an image forming system that includes a monitoring apparatus according to an exemplary embodiment of the present disclosure;

FIG. 2 is a schematic diagram illustrating an image forming apparatus that generates an audit log monitored by a monitoring apparatus according to an exemplary embodiment of the present disclosure;

FIG. 3A is a block diagram illustrating a hardware configuration of a monitoring apparatus according to an exemplary embodiment of the present disclosure;

FIG. 3B is a block diagram illustrating a functional configuration of the monitoring apparatus according to the exemplary embodiment of the present disclosure; and

FIG. 4 is a flowchart illustrating the flow of monitoring of an audit log server and the like by a monitoring apparatus according to an exemplary embodiment of the present disclosure.

### DETAILED DESCRIPTION

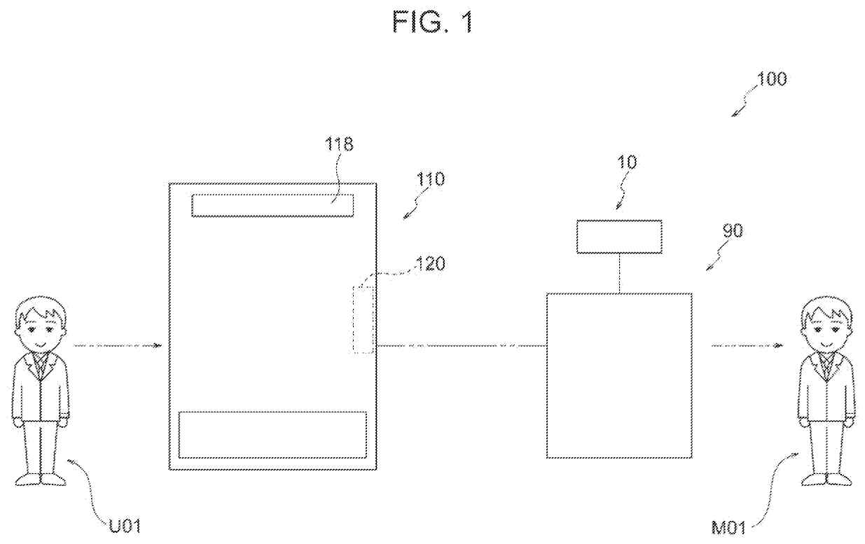

Examples of a monitoring apparatus and a monitoring program according to an exemplary embodiment of the present disclosure will be described below with reference to FIGS. 1 to 4. In the drawings, the same or equivalent component elements and parts are denoted by the same reference signs. Furthermore, for convenience of explanation, dimensional ratios in the drawings are exaggerated and may be different from actual ratios.

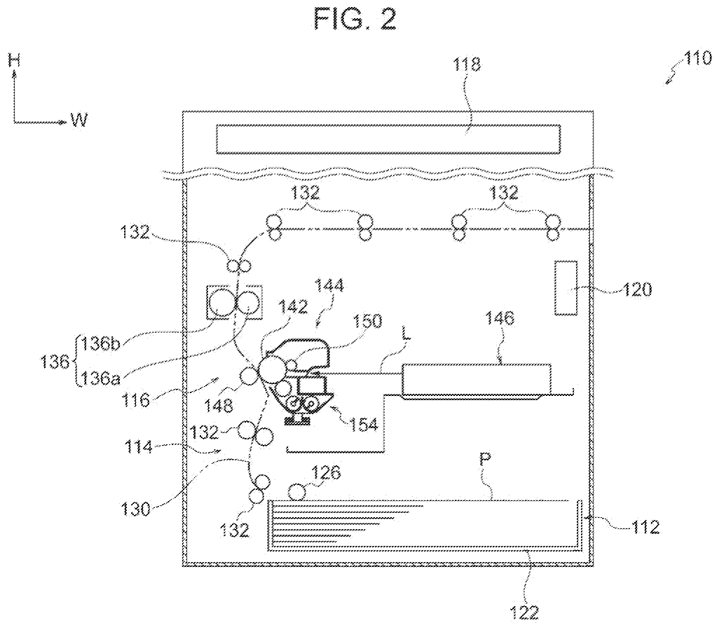

An arrow H in FIG. 2 indicates the vertical direction and up-down direction, and an arrow W indicates the horizontal direction and width direction. First, the schematic configuration of an image forming system 100 that includes a monitoring apparatus 10 will be described.

(Image Forming System 100)

The image forming system 100 includes, as illustrated in FIG. 1, an image forming apparatus 110 that forms an image on a sheet member P as a recording medium in response to an instruction from a user (hereinafter, an “execution user U01”) who has executed a printing instruction. The image forming system 100 also includes an audit log server 90 that receives an audit log from the image forming apparatus 110 and the monitoring apparatus 10 that monitors the audit log received by the audit log server 90. The printing instruction is a so-called print job, a processing unit of printing operation performed in response to a single instruction from the execution user U01, and image information containing attributes including printing speed, area coverage (resolution) of an image, and the like.

[Image Forming Apparatus 110]

As illustrated in FIG. 2, the image forming apparatus 110 includes a paper housing unit 112 that houses the sheet member P, a transport unit 114 that transports the sheet member P, and an image forming unit 116 that performs image formation on the transported sheet member P. The image forming apparatus 110 further includes an operation screen 118 that is operated by a user and a controller 120 that controls the units that configure the image forming apparatus 110.

Paper Housing Unit 112

The paper housing unit 112 includes, as illustrated in FIG. 2, a housing part 122 that is capable of housing the sheet member P and an output roller 126 that outputs the sheet member P housed in the housing part 122 to a transport path 130 for the sheet member P.
Transport Unit 114

The transport unit 114 includes, as illustrated in FIG. 2, a plurality of transport rollers 132 that transport, along the transport path 130, the sheet member P that has been output from the housing part 122 to the transport path 130.

Image Forming Unit 116

The image forming unit 116 includes, as illustrated in FIG. 2, an image forming part 144, an exposure device 146 that applies exposure light L to an image holder 142 of the image forming part 144 and forms an electrostatic latent image, and a transfer roller 148 that transfers a toner image formed by the image forming part 144 onto the sheet member P. The image forming unit 116 further includes a fixing device 136 that fixes the transferred toner image to the sheet member P.

The image forming part 144 includes a charger 150 that charges the outer peripheral surface of the image holder 142, which is rotating, and a developer 154 that develops the electrostatic latent image formed on the image holder 142 by the exposure device 146 into a toner image. Furthermore, the transfer roller 148 is disposed opposite the image holder 142 with the transport path 130 interposed therebetween.

The fixing device 136 is disposed downstream the transfer roller 148 in a direction in which the sheet member P is transported and includes a heating roller 136a and a pressure roller 136b, as illustrated in FIG. 2.

With this arrangement, the heating roller 136a and the pressure roller 136b rotate, and the sheet member P is transported with being placed between the heating roller 136a and the pressure roller 136b. Thus, the toner image that has been transferred to the sheet member P is fixed to the sheet member P by heat and pressure.
Operation Screen 118

The operation screen 118 is a so-called user interface and is a screen on which a user using the image forming apparatus 110 transfers information to and from the image forming apparatus 110. Specifically, the operation screen 118 is a screen on which the user instructs the image forming apparatus 110 to perform an image forming operation or the like and on which the user is notified of the operating state of the image forming apparatus 110.

Controller 120

The controller 120 controls the units that configure the image forming apparatus 110, generates an audit log capable of being used to confirm that a printing instruction from the execution user U01 has been executed in accordance with a predetermined method, and transmits the audit log to the audit log server 90.

The audit log contains identification information for identifying a document printed in accordance with a printing instruction, date and time at which the printing instruction was executed, the name (ID) of an execution user who executed the printing instruction, the name of an image forming apparatus used to execute the printing instruction, and the number of printed copies.

The audit log also contains information indicating whether the execution user U01 has executed the printing instruction by inserting a memory such as a universal serial bus (USB) memory that stores a document into the image forming apparatus 110 and operating the operation screen 118 of the image forming apparatus 110 or the execution user U01 has executed the printing instruction using a personal computer of the execution user U01.

[Audit Log Server 90]

The audit log server 90 illustrated in FIG. 1 receives an audit log from the controller 120 of the image forming apparatus 110 in a wired or wireless manner, and stores and manages the received audit log.

[Monitoring Apparatus 10]

The monitoring apparatus 10 illustrated in FIG. 1 monitors an audit log that the audit log server 90 receives. When the audit log server 90 receives an audit log containing printing information indicating that a document specified in advance (hereinafter, a “specified document”) has been printed, the monitoring apparatus 10 causes the audit log server 90 to notify a document manager M01 of the audit log of the specified document via e-mail. In other words, in the case where printing information of the image forming apparatus managed by the audit log server contains printing information indicating that a specified document has been printed, the monitoring apparatus 10 causes the audit log server 90 to notify the document manager M01 of contents of an audit log that records the fact that the specified document has been printed. The document manager M01 is a person who is in charge of handling of a specified document. In this exemplary embodiment, the document manager M01 is a person who has created a specified document.

The specified document is a document created using document creation software having an e-mail transmission function and the e-mail transmission function is enabled for the document. Specifically, to enable the e-mail transmission function, an e-mail address needs to be entered. In other words, when the document manager M01 who has created a document enables the e-mail transmission function and an e-mail address of the document manager M01 is entered, the created document becomes a specified document.

With this arrangement, the execution user U01 executes a printing instruction for a specified document and prints the specified document using the image forming apparatus 110. Thus, an audit log indicating that the printing instruction has been executed is generated, and is transmitted to the audit log server 90. The monitoring apparatus 10 monitors the audit log and causes the audit log server 90 to notify the document manager M01 of the audit log of the specified document via e-mail.

Hardware Configuration of Monitoring Apparatus 10

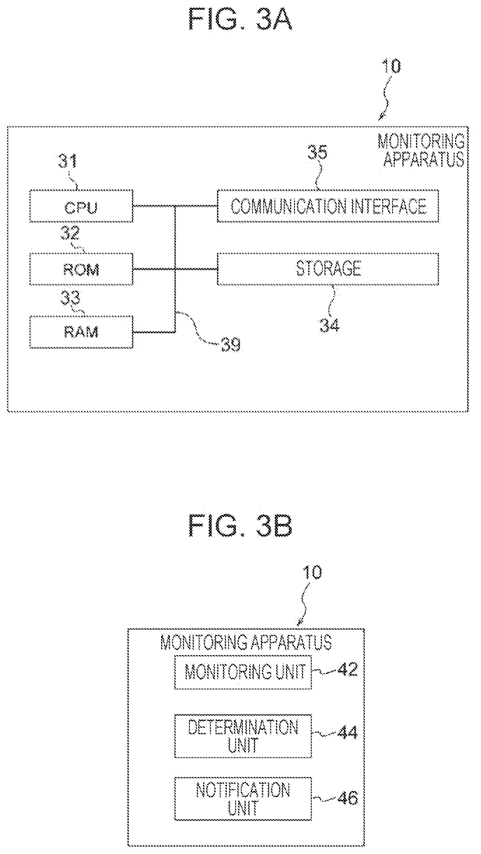

The image forming system 100 includes, as illustrated in FIG. 3A, a central processing unit (CPU) 31, a read only memory (ROM) 32, a random access memory (RAM) 33, a storage 34, and a communication interface (I/F) 35. These component elements of the monitoring apparatus 10 are connected to one another so that they are capable of communicating with one another through a bus 39.

The CPU 31 executes various programs and controls the units that configure the monitoring apparatus 10. That is, the CPU 31 reads a program from the ROM 32 or the storage 34 and executes the program using the RAM 33 as a working area. The CPU 31 performs control of the component elements of the monitoring apparatus 10 and various types of arithmetic processing in accordance with the program recorded in the ROM 32 or the storage 34. In this exemplary embodiment, for example, a monitoring program for monitoring an audit log transmitted to the audit log server 90 is stored in the ROM 32 or the storage 34.

The ROM 32 stores various programs and various data. The RAM 33 temporarily stores a program or data as a working area. The storage 34 includes a hard disk drive (HDD) or a solid state drive (SSD) and stores various programs including an operating system and various data. The communication interface 35 is an interface for allowing the monitoring apparatus 10 to communicate with the image forming apparatus 110 and the like. For example, standards such as Ethernet®, Fiber Distributed Data Interface (FDDI), or Wi-Fi® are used for the communication interface 35.

For execution of the above-mentioned processing program, the monitoring apparatus 10 implements various functions using the above-mentioned hardware resources. A functional configuration implemented by the monitoring apparatus 10 will be described below.

Functional Configuration of Monitoring Apparatus 10

The monitoring apparatus 10 includes, as illustrated in FIG. 3B, a monitoring unit 42, a determination unit 44, and a notification unit 46. These functional configurations are implemented when the CPU 31 reads the monitoring program stored in the ROM 32 or the storage 34 and executes the monitoring program.

The monitoring unit 42 determines whether or not an audit log transmitted to the audit log server 90 is an audit log of a specified document. The determination unit 44 determines, based on the audit log of the specified document, whether or not a printing instruction has been executed by an operation on the operation screen 118 of the image forming apparatus 110. The notification unit 46 causes the audit log server 90 to notify the document manager M01 of the audit log of the printed specified document by attaching the audit log to an e-mail.

(Operation of Monitoring Apparatus 10)

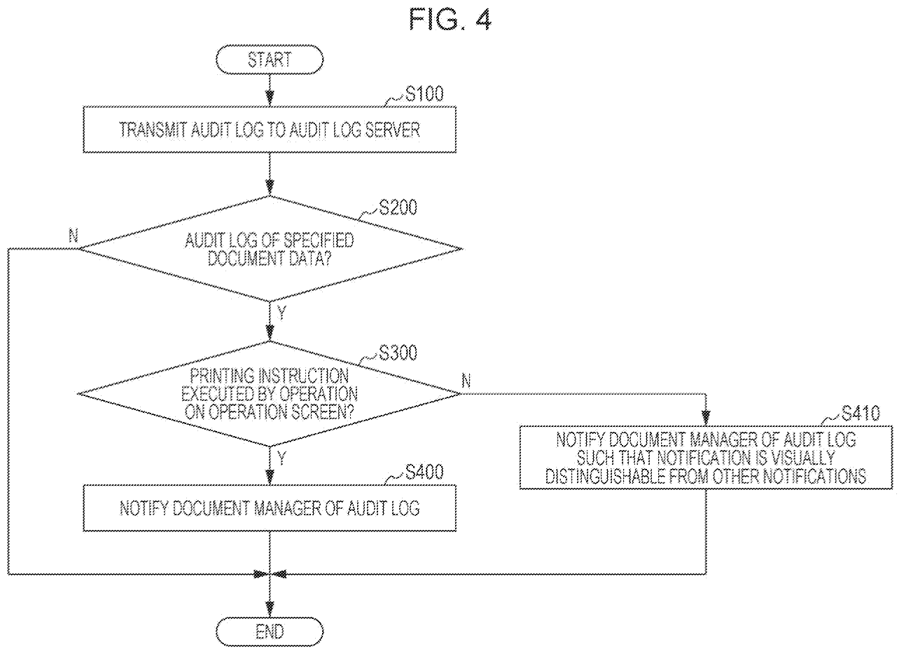

Next, an operation of the monitoring apparatus 10 will be described below with reference to a flowchart of FIG. 4.

When the execution user U01 executes a printing instruction for printing a document and the document is printed by the image forming apparatus 110, the image forming apparatus 110 transmits an audit log of the executed printing instruction to the audit log server 90 in step S100.

In step S200, the monitoring unit 42 determines whether or not the audit log transmitted to the audit log server 90 is an audit log of a specified document. In the case where the transmitted audit log is an audit log of the specified document, the process proceeds to step S300. In the case where the transmitted audit log is not an audit log of the specified document, the series of processing operations ends.

In step S300, the determination unit 44 determines whether or not the printing instruction has been executed by insertion of a memory such as a USB memory that stores the document into the image forming apparatus 110 and operation on the operation screen 118 of the image forming apparatus 110. In the case where the printing instruction has been executed by an operation on the operation screen 118, the process proceeds to step S400. In the case where the printing instruction has not been executed by an operation on the operation screen 118, the process proceeds to step S410.

In step S400, the notification unit 46 causes the audit log server 90 to notify the document manager M01 of the audit log of the printed specified document by attaching the audit log to an e-mail. The notification unit 46 causes the audit log server 90 to also notify the document manager M01 of the first page of the printed specified document by attaching the first page of the printed specified document to the e-mail. This is because a title or the like of the specified document is provided in the first page.

Specifically, the audit log server 90 acquires image data of the first page of the specified document from the image forming apparatus 110. Then, the notification unit 46 causes the audit log server 90 to attach the image data to the e-mail.

In contrast, when it is determined in step S300 that the printing instruction has not been executed by an operation on the operation screen 118, the process proceeds to step S410. In step S410, the notification unit 46 causes the audit log server 90 to transmit a notification to the document manager M01 in such a manner that the document manager M01 is able to distinguish the notification from other notifications. In this case, the document manager M01 is able to visually distinguish the notification from other notifications by viewing the subject of the e-mail. For example, a word “Caution” or “Important” may be inserted in the beginning of the subject of the e-mail.

The reason why it is necessary to distinguish the notification from other notifications is that, in the case where the printing instruction has not been executed by an operation on the operation screen 118, the printing instruction is highly likely to have been executed using a private personal computer that is distant from the image forming apparatus 110, and a printed material of a highly confidential specified document may be output from the image forming apparatus 110 and left unattended.

When the notification unit 46 causes the audit log server 90 to notify the document manager M01 of the audit log of the printed specified document by attaching the audit log to the e-mail in step S410 as described above, the series of processing operations ends.

When the image forming apparatus 110 transmits an audit log of a newly executed printing instruction to the audit log server 90, the above-mentioned steps are repeated.

(Conclusion) As described above, in the monitoring apparatus 10, the monitoring unit 42 determines whether or not an audit log transmitted from the image forming apparatus 110 to the audit log server 90 is an audit log of a specified document. Furthermore, in the case where the transmitted audit log is an audit log of a specified document, the notification unit 46 causes the audit log server 90 to notify the document manager M01 of the audit log of the printed specified document by attaching the audit log to an e-mail. Thus, in the case where the specified document specified by the document manager M01 who has created the document has been printed by the execution user U01 who is a different user, the document manager M01 understands that the specified document has been printed.

Furthermore, the monitoring apparatus 10 causes the audit log server 90 to also notify the document manager M01 of the first page of the printed specified document by attaching the first page of the printed specified document to the e-mail. Thus, compared to a case where the document manager M01 is notified of the audit log without none of the pages of the specified document being attached to the e-mail, the document manager M01 is able to easily understand what specified document has been printed.

Furthermore, the monitoring apparatus 10 causes the audit log server 90 to also notify the document manager M01 of the first page of the printed specified document by attaching the first page of the printed specified document to the e-mail. Thus, compared to a case where the document manager M01 is notified of the audit log with the final page of the specified document being attached to the e-mail, the document manager M01 is able to easily understand what specified document has been printed.

Furthermore, the monitoring apparatus 10 causes the audit log server 90 to also notify the document manager M01 of information about whether or not the specified document has been printed by an operation on the operation screen 118 of the image forming apparatus 110. Thus, the document manager M01 is able to know that the specified document may have been output from the image forming apparatus 110 without the execution user U01 having been present near the image forming apparatus 110. In other words, the document manager M01 is able to know that the specified document may be output from the image forming apparatus 110 and left unattended.

Furthermore, in the case where the specified document has not been printed by an operation on the operation screen 118 of the image forming apparatus 110, the monitoring apparatus 10 causes the audit log server 90 to notify the document manager M01 of the audit log in such a manner that the document manager M01 is able to distinguish the notification from other notifications. Thus, compared to the case where the notification is similar to other notifications, the document manager M01 is able to easily understand that the specified document may have been output from the image forming apparatus 110 without the execution user U01 having been present near the image forming apparatus 110.

Furthermore, in the monitoring program, in the case where a specified document specified by the document manager M01 who has created the document has been printed by the execution user U01, who is a different user, the document manager M01 understands that the specified document has been printed.

A specific exemplary embodiment of the present disclosure has been described in detail above. However, it is obvious to those skilled in the art that the present disclosure is not limited to the exemplary embodiment described above and various other exemplary embodiments may be possible within the scope of the present disclosure. For example, although not particularly described in the foregoing exemplary embodiment, only an identification letter for identifying the execution user U01 may be added to the subject of an e-mail. Thus, a document manager is able to understand who has executed the printing instruction only by viewing the subject.

Furthermore, in the exemplary embodiment described above, the monitoring apparatus 10 causes the audit log server 90 to notify the document manager M01 of contents of an audit log by attaching the audit log to an e-mail. However, the audit log is not necessarily attached to the e-mail. The monitoring apparatus 10 may cause the audit log server 90 to notify the document manager M01 of the contents of the audit log by adding the contents of the audit log to text of the e-mail.

Furthermore, although not particularly described in the exemplary embodiment described above, regarding the time at which the controller 120 of the image forming apparatus 110 transmits an audit log to the audit log server 90, the controller 120 of the image forming apparatus 110 may transmit an audit log to the audit log server 90 every time that an printing instruction is executed or may transmit a plurality of audit logs collectively after a plurality of printing instructions are executed.

Furthermore, although not particularly described in the exemplary embodiment described above, the monitoring apparatus 10 may be included in the audit log server 90.

Furthermore, although not particularly described in the exemplary embodiment described above, the monitoring apparatus 10 effectively operates especially, for example, in a shared office in which an audit log that records the fact that a document or the like has been printed is not easily available.

Furthermore, in the exemplary embodiment described above, the controller 120 of the image forming apparatus 110 generates an audit log. However, the audit log server 90 that has received information necessarily for generating an audit log from the image forming apparatus 110 may generate an audit log.

Furthermore, in the exemplary embodiment, the image forming apparatus 110 of a xerography type has been described as an example. However, the image forming apparatus 110 may be of an inkjet type.

Furthermore, a process executed by the CPU 31 that has read software (program) in an exemplary embodiment described above may be performed by various processors other than the CPU. In this case, the various processors include, for example, a programmable logic device (PLD) that is capable of changing a circuit configuration after a field-programmable gate array or the like is manufactured, a dedicated electric circuit as a processor having a dedicated circuit configuration designed for performing a specific process such as an Application Specific Integrated Circuit (ASIC), and the like. Furthermore, a mode change process may be performed by one of the various processors or may be performed by a combination of two or more processors of the same type or different types (for example, a combination of a plurality of FPGAs, a combination of a CPU and an FPGA, or the like). Furthermore, the hardware structure of the various processors is, more specifically, an electric circuit including a combination of circuit elements such as semiconductor elements.

Furthermore, an aspect in which a program is stored (installed) in advance in the ROM 32 or the storage 34 has been described in each of the exemplary embodiments described above. However, the present disclosure is not limited to this aspect. The program may be recorded in a recording medium such as a compact disk-read only memory (CD-ROM), a digital versatile disk-read only memory (DVD-ROM), or a USB memory and provided. Furthermore, the program may be downloaded from an external apparatus through a network.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

A monitoring apparatus comprising:
a processor configured to:
   in a case where printing information of an image forming apparatus managed by an audit log server contains information indicating that a specified document specified in advance has been printed by the image forming apparatus, cause the audit log server to notify a document manager who manages the specified document of contents of an audit log that records a fact that the specified document has been printed.
      (((2)))

The monitoring apparatus according to (((1))), wherein the processor is configured to cause the audit log server to also notify the document manager of at least part of pages of the specified document.

(((3)))

The monitoring apparatus according to (((2))), wherein the processor is configured to cause the audit log server to notify the document manager of a first page of the specified document.

(((4)))

The monitoring apparatus according to any one of (((1))) to (((3))), wherein the processor is configured to cause the audit log server to also notify the document manager of information about whether or not the specified document has been printed by an operation on an operation screen of the image forming apparatus.

(((5)))

The monitoring apparatus according to (((4))), wherein the processor is configured to, in a case where the specified document has been printed by an operation different from the operation on the operation screen, cause the audit log server to notify the document manager of the audit log in such a manner that the document manager is able to distinguish the notification from other notifications.

(((6)))

A monitoring program for causing a computer to execute a process comprising:
in a case where printing information of an image forming apparatus managed by an audit log server contains information indicating that a specified document specified in advance has been printed by the image forming apparatus, causing the audit log server to notify a document manager who manages the specified document of contents of an audit log that records a fact that the specified document has been printed.

What is claimed is:

1. A monitoring apparatus comprising:
a processor configured to:
in a case where printing information of an image forming apparatus managed by an audit log server contains information indicating that a specified document specified in advance has been printed by the image forming apparatus, cause the audit log server to notify a document manager who manages the specified document of contents of an audit log that records a fact that the specified document has been printed.

2. The monitoring apparatus according to claim 1, wherein the processor is configured to cause the audit log server to also notify the document manager of at least part of pages of the specified document.

3. The monitoring apparatus according to claim 2, wherein the processor is configured to cause the audit log server to notify the document manager of a first page of the specified document.

4. The monitoring apparatus according to claim 1, wherein the processor is configured to cause the audit log server to also notify the document manager of information about whether or not the specified document has been printed by an operation on an operation screen of the image forming apparatus.

5. The monitoring apparatus according to claim 4, wherein the processor is configured to, in a case where the specified document has been printed by an operation different from the operation on the operation screen, cause the audit log server to notify the document manager of the audit log in such a manner that the document manager is able to distinguish the notification from other notifications.

6. A monitoring method comprising:
in a case where printing information of an image forming apparatus managed by an audit log server contains information indicating that a specified document specified in advance has been printed by the image forming apparatus, causing the audit log server to notify a document manager who manages the specified document of contents of an audit log that records a fact that the specified document has been printed.

7. A non-transitory computer readable medium storing a program causing a computer to execute a process for monitoring, the process comprising:
in a case where printing information of an image forming apparatus managed by an audit log server contains information indicating that a specified document specified in advance has been printed by the image forming apparatus, causing the audit log server to notify a document manager who manages the specified document of contents of an audit log that records a fact that the specified document has been printed.
